(19) United States
(12) Patent Application Publication
(10) Pub. No.: US 2013/0299480 A1
(43) Pub. Date: Nov. 14, 2013

(54) HEATER AND IMAGE HEATING APPARATUS INCLUDING THE HEATER

(71) Applicant: CANON KABUSHIKI KAISHA, Tokyo (JP)

(72) Inventors: Kouichi Kakubari, Toride-shi (JP); Toshinori Nakayama, Kashiwa-shi (JP); Taichi Takemura, Abiko-shi (JP); Toshihisa Yago, Toride-shi (JP); Kota Arimoto, Kashiwa-shi (JP); Ryo Suzuki, Kashiwa-shi (JP); Kazuhiro Hasegawa, Abiko-shi (JP)

(73) Assignee: CANON KABUSHIKI KAISHA, Tokyo (JP)

(21) Appl. No.: 13/891,516

(22) Filed: May 10, 2013

(30) Foreign Application Priority Data
May 14, 2012 (JP) 2012-110421

(51) Int. Cl. H05B 3/00; G03G 15/20

(52) U.S. Cl. CPC G03G 15/2053
USPC 219/216; 399/329

(57) ABSTRACT

A heater includes: a substrate; a resistor, provided obliquely on the substrate with respect to a sheet passing direction, for generating heat by electric energy supply; a pair of first electrodes which are disposed opposed to each other via the resistor and which are electrically connected with respective ends of the resistor with respect to the sheet passing direction; and a pair of second electrodes which are disposed opposed to each other via the resistor and which are electrically connected with respective ends of the resistor with respect to the sheet passing direction. One of the first electrodes and one of the second electrodes overlap with each other as seen from the sheet passing direction.

### FIELD OF THE INVENTION AND RELATED ART

The present invention relates to a heater for heating an image on a sheet and an image heating apparatus including the heater.

A fixing apparatus (image heating apparatus) for fixing the image on a recording material (sheet) by heat supplied from the heater via a fixing belt (endless belt) has been known conventionally. For example, in the fixing apparatus described in Japanese Laid-Open Patent Application (JP-A) 2008-299205, an electrode is provided, over a whole region of a heat generating resistor formed on a substrate with respect to a longitudinal direction, in an end side of the heat generating resistor with respect to a recording material conveyance direction, and a plurality of electrodes divided with respect to the longitudinal direction is provided on the heat generating resistor in another end side of the heat generating resistor with respect to the recording material conveyance direction. As a result, electric energy is supplied to the heat generating resistor along the recording material conveyance direction.

However, in another end side of the heat generating resistor with respect to the recording material conveyance direction, the electrodes are provided in a state in which the electrodes are divided with respect to the longitudinal direction and therefore have a structure such that it is difficult to carry a current to the heat generating resistor between adjacent electrodes. As a result, a region where a temperature is low is generated between the adjacent electrodes with respect to the longitudinal direction, so that there is a possibility that improper fixing and uneven glossiness occur at a corresponding portion.

### SUMMARY OF THE INVENTION

A principal object of the present invention is to provide a heater capable of suppressing temperature lowering between electrodes disposed adjacently to each other with respect to a longitudinal direction.

Another object of the present invention is to provide an image heating apparatus capable of suppressing the temperature lowering between the adjacent electrodes.

According to an aspect of the present invention, there is provided a heater comprising: a substrate; a resistor, provided obliquely on the substrate with respect to a sheet passing direction, for generating heat by electric energy supply; a first pair of electrodes which are disposed opposed to each other via the resistor and which are electrically connected with respective ends of the resistor with respect to the sheet passing direction; and a second pair of electrodes which are disposed opposed to each other via the resistor and which are electrically connected with respective ends of the resistor with respect to the sheet passing direction, wherein one of the first electrodes and one of the second electrodes overlap with each other as seen from the sheet passing direction.

According to another aspect of the present invention, there is provided an image heating apparatus comprising: (i) an endless belt for heating an image on a sheet at a nip; (ii) a rotatable driving member for forming the nip in cooperation with the endless belt and for driving the endless belt; (iii) a heater, provided to sandwich the endless belt between itself and the rotatable driving member, for heating the endless belt, wherein the endless belt comprises: (iii-1) a substrate; (iii-ii) a resistor, provided obliquely on the substrate with respect to a sheet passing direction, for generating heat by electric energy supply; (iii-iii) a pair of first electrodes which are disposed opposed to each other via the resistor and which are electrically connected with respective ends of the resistor with respect to the sheet passing direction; and (iii-iv) a pair of second electrodes which are disposed opposed to each other via the resistor and which are electrically connected with respective ends of the resistor with respect to the sheet passing direction, wherein one of the first electrodes and one of the second electrodes overlap with each other as seen from the sheet passing direction.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic cross-sectional view showing an example of a general structure of an image forming apparatus.

FIG. 2 is a schematic cross-sectional view showing a general structure of a fixing apparatus.

Part (a) of FIG. 3 is a front view showing a general structure of a heater in a fixing film sliding side, (b) of FIG. 3 is a sectional view of the heater with respect to a widthwise direction in an end side with respect to a longitudinal direction of the heater, (c) of FIG. 3 is a sectional view of the heater with respect to the widthwise direction at a longitudinal central portion of the heater, and (d) of FIG. 3 is a sectional view of the heater with respect to the widthwise direction in another end side with respect to the longitudinal direction of the heater.

FIG. 4 is an illustration showing a relationship among a substrate, a heat generating resistor layer and an electroconductive pattern with respect to the longitudinal direction of the heater.

FIG. 5 is a schematic front view showing a fixing film sliding-side structure of a heater in Comparison example.

Parts (a) and (b) of FIG. 6 are graphs showing differences in toner distribution (glossiness distribution) with respect to a longitudinal direction of a heater in Embodiment 1 and a heater in Comparison example, respectively.

Part (a) of FIG. 7 is a schematic front view showing a fixing film sliding-side structure of the heater, and (b) of FIG. 7 is an illustration showing a certain condition for arranging a heat generating resistor layer and an electroconductive pattern on a substrate.

FIG. 8 is an illustration showing non-sheet-passing portion temperature rise of the fixing apparatus.

### DESCRIPTION OF THE PREFERRED EMBODIMENTS

Embodiments of the present invention will be specifically described with reference to the drawings.

### Embodiment 1

### (1) Image Forming Apparatus

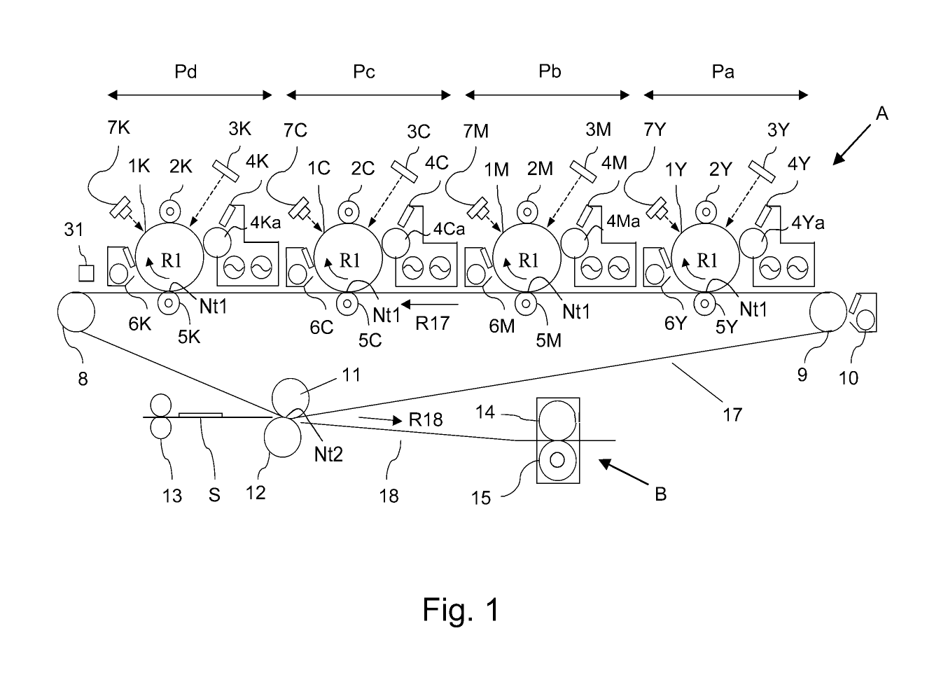

FIG. 1 is a schematic cross-sectional view showing an example of a general structure of an image forming apparatus in which an image heating apparatus according to the present invention is mounted as a fixing apparatus (fixing device). This image forming apparatus is a four color-based full-color electrophotographic laser printer.

The image forming apparatus shown in FIG. 1 is roughly divided into an image forming portion A for forming an unfixed toner image on a recording material and a fixing portion (fixing apparatus) B for heat-fixing the unfixed toner image, carried on the recording material, on the recording material.

At the image forming portion A, from an upstream side to a downstream side of an intermediary transfer belt 17 as an intermediary transfer member along a rotational direction (arrow R17 direction) of the intermediary transfer belt 17, four image forming stations Pa, Pb, Pc and Pd are provided. The image forming stations Pa, Pb, Pc and Pd are constituted to form toner images of colors of yellow, magenta, cyan and black, respectively, in this order, and include drum-type electrophotographic photosensitive members (photosensitive drums) 1Y, 1M, 1C and 1K, respectively, as an image bearing member.

The photosensitive drums 1Y, 1M, 1C and 1K are rotationally driven in arrow R1 directions, respectively. At peripheries of the photosensitive drums 1Y, 1M, 1C and 1K, along their rotational directions, charging devices (charging means) 2Y, 2M, 2C and 2K and exposure device (latent image forming means) 3Y, 3M, 3C and 3K are provided in this order. Further, developing devices (developing means) 4Y, 4M, 4C and 4K, primary transfer rollers (primary transfer means) 5Y, 5M, 5C and 5K, drum cleaners (cleaning means) 6Y, 6M, 6C and 6K, and the like are provided in this order.

Further, below the intermediary transfer belt 17, a transfer conveying guide 18 is provided, and the fixing apparatus B is provided in a downstream side of a conveying guide direction (arrow R18 direction in FIG. 1) of a recording material S such as a recording sheet conveyed by the transfer conveying guide 18.

In the following description, there is no need to particularly differentiate the colors of the photosensitive drums 1Y, 1M, 1C and 1K and the charging devices 2Y, 2M, 2C and 2K, and therefore the photosensitive drums and the charging devices are simply referred to as the photosensitive drum(s) 1 and the charging device(s) 2. Similarly, the exposure devices 3Y, 3M, 3C and 3K, the developing devices 4Y, 4M, 4C and 4K, the primary transfer rollers 5Y, 5M, 5C and 5K, and the drum cleaners 6Y, 6M, 6C and 6K are simply referred to as the exposure device(s) 3, the developing device(s) 4, the primary transfer roller(s) 5 and the drum cleaner(s) 6.

In this embodiment, the photosensitive drum 1 is 30 mm in diameter. The photosensitive drum 1 is formed by applying a photosensitive layer of a predetermined organic photoconductor (OPC) onto an outer peripheral surface of a drum substrate which is grounded and which is formed of an electroconductive material such as aluminum. The photosensitive layer is formed by laminating an undercoating layer (UCL), a charge carrier generating layer (CGL) and a charge carrier transfer layer (CTL).

The photosensitive layer is a predetermined insulating layer and has a property such that it is irradiated with light of specific wavelength to become an electroconductive member. This is because positive holes are generated in the charge carrier generating layer by the light irradiation and function as a carrier of flow of electric charges. The charge carrier generating layer is formed of a phthalocyanine compound in a thickness of 0.2 Tim, and the charge carrier transfer layer is about 25 μm in thickness and is constituted by polycarbonate in which a hydrazone compound is dispersed.

As the charging device, a charging roller 2 is used. The charging roller 2 is disposed in contact with the surface of the photosensitive drum 1. The charging roller 2 has a structure in which an electroconductive core metal is provided at the center thereof and on an outer peripheral surface, an electroconductive elastic layer, a medium-resistance electroconductive layer and a low-resistance electroconductive layer are formed.

The charging roller 2 is rotatably shaft-supported by bearings (not shown) at end portions and is disposed in parallel to a rotational axis of the photosensitive drum 1. Each of the bearings at the end portions of the charging roller 2 is pressed at predetermined pressure by an elastic member (not shown) such as a spring with respect to a direction perpendicular to a direction of generatrix of the photosensitive drum 1. By the pressure, the outer peripheral surface of the charging roller 2 is press-contacted to the outer peripheral surface of the photosensitive drum 1, whereby the charging roller 2 is rotated by rotation of the photosensitive drum 1.

As the exposure device 3, a laser scanner for turning on and off laser light depending on image information is used. The laser light generated from the laser scanner scans and exposes the charged surface of the photosensitive drum 1 via a reflection mirror. As a result, the electric charges of a laser light irradiation portion are removed at the charged surface of the photosensitive drum 1, so that an electrostatic latent image depending on the image information is formed on the charged surface of the photosensitive drum 1.

As the developing device 4, the developing device in which a two-component developer is accommodated is used. At openings where the developing devices 4 oppose the photosensitive drums 1, developing sleeves 4Ya, 4Ma, 4Ca and 4Ka are rotatably provided.

Above the developing device 4, a toner container (not shown) which accommodates therein a toner for supply and which is detachably mountable to the developing device 4 is provided. The toner for supply in an amount corresponding to that of the toner consumed by the development passes from a supplying opening, provided to the toner container, through a supplying conveying path (not shown), and then is supplied from a supplying opening, provided to a developing container of the developing device 4, into the developing container. In the supplying conveying path, a supplying screw is provided, and the amount of the toner supplied into the developing container is adjusted by controlling a rotation time of the supplying screw.

An endless belt-like intermediary transfer belt 17 as the intermediary transfer member is extended around two follower rollers 8 and 9, the primary transfer rollers 5 and a secondary transfer opposite roller 11. The intermediary transfer belt 11 is urged by the primary transfer rollers 5 from an inner peripheral surface side thereof to be contacted to the surfaces of the photosensitive drums 1 at its outer peripheral surface. As a result, a primary transfer nip (primary transfer portion) Nt1 is formed by the surface of the photosensitive drum 1 and the surface of the intermediary transfer belt 17.

On the surface of the intermediary transfer belt 17, a secondary transfer roller 12 is provided so as to oppose the secondary transfer opposite roller 11 via the intermediary transfer belt 17. The secondary transfer roller 12 is urged against the intermediary transfer belt 17, so that the outer peripheral surface of the secondary transfer roller 12 is contacted to the surface of the intermediary transfer belt 17. As a result, a secondary transfer nip (secondary transfer portion) Nt2 is formed by the surface of the intermediary transfer belt 17 and the surface of the secondary transfer roller 12.

The intermediary transfer belt 17 is rotated in an arrow R17 direction by rotation of the secondary transfer opposite roller 11, in the arrow R17 direction, also functioning as a driving roller. A rotational speed of the intermediary transfer belt 17 is set at a value substantially equal to a rotational speed (process speed) of each photosensitive drum 1.

Next, an image forming operation of the above-constituted image forming apparatus will be described. In the image forming apparatus in this embodiment, a predetermined motor (not shown) is rotationally driven depending on a print job signal, so that the photosensitive drums 1 of the image forming stations Pa, Pb, Pc and Pd are rotated in the arrow R1 directions.

First, in the image forming station Pa for a first color of yellow, the surface of the photosensitive drum 1 is electrically charged uniformly to predetermined polarity and potential by the charging roller 2 (charging step). Then, the charged surface of the photosensitive drum 1 is subjected to scanning exposure to the laser light emitted from the laser scanner 3, so that the electrostatic latent image depending on the image information is formed on the surface of the photosensitive drum 1 (exposure step). The latent image is developed with the toner of yellow by the developing device 4 (developing step). As a result, on the surface of the photosensitive drum 1, a yellow toner image is formed.

Similarly, the steps of the charging, the exposure and the development are performed also at the image forming stations Pb, Pc and Pd for second, third and fourth colors of magenta, cyan and black, respectively. Thus, the respective color toner images are formed on the surfaces of the photosensitive drums 1 in the image forming stations Pa, Pb, Pc and Pd.

These toner images of the four colors are successively primary-transferred onto the outer peripheral surface of the intermediary transfer belt 17 by applying a transfer bias to the primary transfer rollers 5 at the primary transfer nips Nt1. Thus, the four color toner images are superposed on the surface of the intermediary transfer belt 17. After the primary transfer, a toner (residual toner) remaining on the surface of each photosensitive drum 1 without being transferred onto the intermediary transfer belt 17 is removed by the drum cleaner 6. The photosensitive drum 1 from which the residual toner is removed is subjected to subsequent image formation.

The four color toner images superposed on the intermediary transfer belt 17 as described above are secondary-transferred onto the recording material S. That is, the recording material S fed from a sheet feeding cassette (not shown) by a sheet feeding device is supplied to the secondary transfer nip Nt2 while being timed to the toner images on the intermediary transfer belt 17 by a registration roller 13. The supplied recording material S is conveyed while being nipped at the secondary transfer nip Nt2 (nip-conveyed) by the surfaces of the intermediary transfer belt 17 and the secondary transfer roller 12. In this conveying process, by applying a secondary transfer bias to the secondary transfer roller 12, unfixed four color toner images on the surface of the intermediary transfer belt 17 are collectively secondary-transferred onto the recording material S. After the secondary transfer, a toner (residual) toner remaining on the intermediary transfer belt 17 without being transferred is removed by a belt cleaner 10.

The recording material S on which the unfixed toner images are secondary-transferred is heated and pressed by the fixing apparatus B, so that the toner images are heat-fixed on the recording material S. The recording material S after the toner images are fixed there of discharged onto a sheet discharge tray (not shown).

In the above-described manner, the four color-based full-color image formation on one surface (side) of a single sheet of the recording material S is ended.

### (2) Fixing Apparatus B

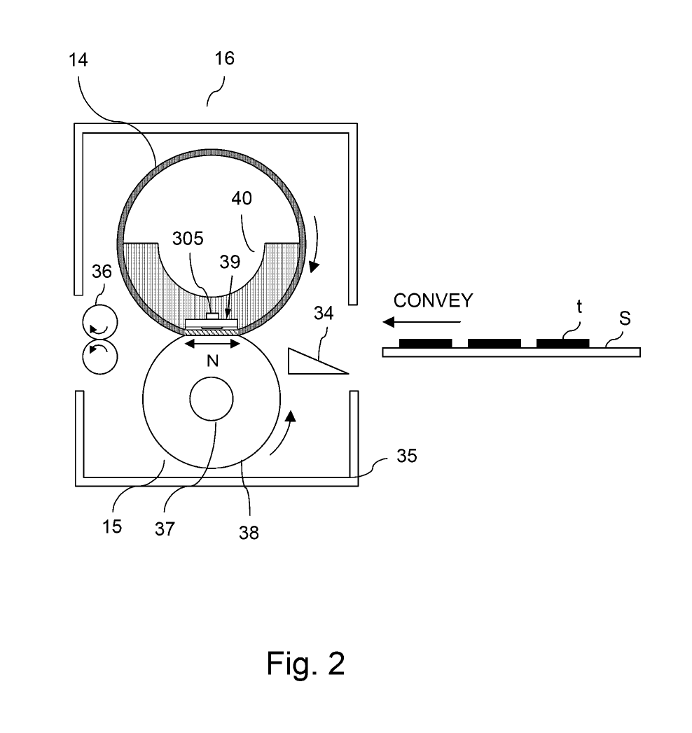

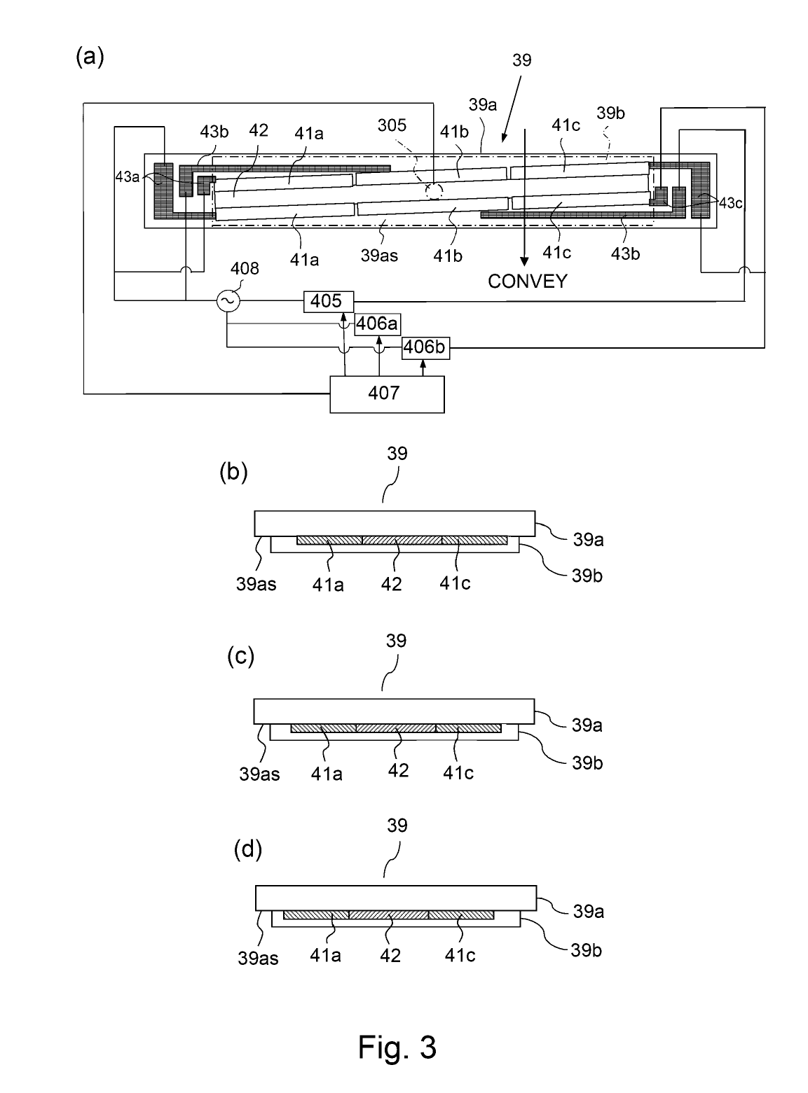

FIG. 2 is a schematic cross-sectional view showing a general structure of the fixing apparatus B. This fixing apparatus B is of a film heating type.

In the following description, with respect to the fixing apparatus and members constituting the fixing apparatus, a longitudinal direction refers to a direction perpendicular to a recording material conveyance direction on the surface of the recording material. A widthwise direction refers to a direction parallel to the recording material conveyance direction on the surface of the recording material. A longitudinal width refers to a dimension with respect to the longitudinal direction. A widthwise (short) width refers to a dimension with respect to the widthwise direction. With respect to the recording material, a longitudinal width refers to a dimension with respect to the longitudinal direction.

The fixing apparatus B in this embodiment includes a cylindrical fixing film 14 as a flexible member, a heater 39 as a heat generating member, a heater holder 40 as a supporting member, a pressing roller 15 as a pressing member, and the like. Each of the fixing film 14, the heater 39, the heater holder 40 and the pressing roller 15 is an elongated member extending in the longitudinal direction.

In the fixing apparatus B in this embodiment, the heater 39 is supported by the heater holder 40, and the fixing film 14 is rotatably and loosely engaged externally with the heater holder 40. The pressing roller 15 is provided so as to oppose the heater 39 via the fixing film 14, the heater holder 40 is urged toward the pressing roller 15 in a perpendicular direction perpendicular to a direction of generatrix of the fixing film 14. As a result, a fixing nip N is formed by the outer peripheral surfaces of the fixing film 14 and the pressing roller 15.

### (2-1) Heater Holder 40

The heater holder 40 formed in a substantially U-shape in cross section is formed of a liquid crystal polymer resin having a high heat-resistant property, and performs the function of supporting the heater 39 at a widthwise central portion of the lower surface and of guiding the fixing film 14 at a widthwise outer peripheral surface. As the liquid crystal polymer (resin), Zenite 7755 (trade name) manufactured by Dupont was used.

The heater holder 40 is supported at its longitudinal electrode pairs by front and rear supporting members (not shown) of an apparatus frame of the fixing apparatus B. Further, the heater holder 40 is urged at its longitudinal end portions by an urging mechanism (not shown) with a force of 156.8 N (16 kgf) in one side, i.e., of 313.6 N (32 kgf) in total in both sides in the perpendicular direction perpendicular to the direction of generatrix of the fixing film 14. As a result, the lower surface (heating surface) of the heater 39 is press-contacted to the fixing film 14 toward an elastic layer (described later) of the pressing roller 15 with a predetermined urging force (pressure), so that the fixing nip N having a predetermined width necessary to heat-fix the unfixed toner images is formed.

### (2-2) Fixing Film 14

The fixing film 14 is a heat-resistant film (endless belt) having a total thickness of 200 μm or less in order to enable a quick start property. The fixing film 14 is prepared by forming a base layer of a heat-resistant resin such as polyimide, polyamideimide, PEEK (polyether ether ketone); or metal or alloy having a heat-resistance property and a high thermal conductivity, such as SUS (stainless steel), Al, Ni, Cu, Zn, or the like.

In the case of the resin-made base layer, in order to improve the thermal conductivity, high thermal conductivity powder of BN, alumina, Al or the like may also be mixed. Further, in order to constitute a long-lifetime fixing apparatus, as the fixing film 14 which has a sufficient strength and which is excellent in durability, the total thickness may preferably be 20 μm or more. Accordingly, the total thickness of the fixing film 14 in the range of 20 μm or more and 200 μm or less is optimum.

Further, in order to ensure an offset preventing property and a recording material separating property, on the outer peripheral surface of the base layer, a parting layer of a heat-resistant resin, having a good parting property, including a fluorine-containing resin such as PTFE, PFE, FEP, ETFE, CTFE or PDV; silicone resin; and the like. These resins are used singly or in mixture. In this embodiment, the parting layer is constituted by a material at least containing PTFE and PFA.

Here, PTFE is polytetrafluoroethylene, PFA is tetrafluoroethylene-perfluoroalkylvinyl ether copolymer, FEF is tetrafluoroethylene-hexafluoropropylene copolymer, ETFE is ethylene-tetrafluoroethylene copolymer, CTFE is polychlorotrifluoroethylene, and PVDF is polyvinylidene fluoride.

As a coating method, dipping of the parting layer after etching of the outer peripheral surface of the base layer, application such as powder spraying, a method in which the outer peripheral surface of the base layer is coated with a tube-like resin material, or a method in which the outer peripheral surface of the base layer is blasted and thereafter a primer layer of an adhesive is applied and then the parting layer is coated on the primer layer may be used.

### (2-3) Pressing Roller 15

The pressing roller (rotatable driving member) 15 is an elastic roller prepared by forming an elastic layer 38, such as an elastic solid layer, an elastic sponge rubber layer or an elastic foam rubber layer, on an outer peripheral surface of a core metal 37 of SUS, SUM (sulfur or sulfur complex free-cutting steel material), Al or the like. The pressing roller 15 is rotatably supported via bearings (not shown) by front and rear supporting members of the apparatus frame 35 at longitudinal end portions of the core metal 37.

Here, the elastic solid rubber layer is formed with a heat-resistant rubber such as a silicone rubber or a fluorine-containing rubber. The elastic sponge rubber layer is formed by foaming the silicone rubber in order to provide a further heat-insulating effect. Further, the elastic foam rubber layer is formed by dispersing a hollow filler (microballoon or the like) in a silicone rubber layer and by incorporating a gas component in a cured material to enhance the heat-insulating effect.

On the outer peripheral surface of the elastic layer 38, a parting layer of perfluoroalkoxy resin (PFA), polytetrafluoroethylene resin (PTFE) or the like may also be formed.

### (2-4) Heater 39

Part (a) of FIG. 3 is a front view showing a general structure of the heater 39 in a fixing film sliding side, (b) of FIG. 13 is a widthwise cross-sectional view of the heater in one longitudinal end side (right side in (a) of FIG. 3), (c) of FIG. 3 is a widthwise cross-sectional view of the heater 39 at a longitudinal central portion, and (d) of FIG. 3 is a widthwise cross-sectional view of the heater 39 in another longitudinal end side (left side in (a) of FIG. 3). In (b), (c) and (d) of FIG. 3, electrodes 43a, 43b and 43c are omitted from illustration.

The heater 39 includes an elongated insulating ceramic substrate 39a formed of alumina, aluminum nitride or the like and extended in the longitudinal direction substrate 39a is formed in a plate shape having a low thermal capacity.

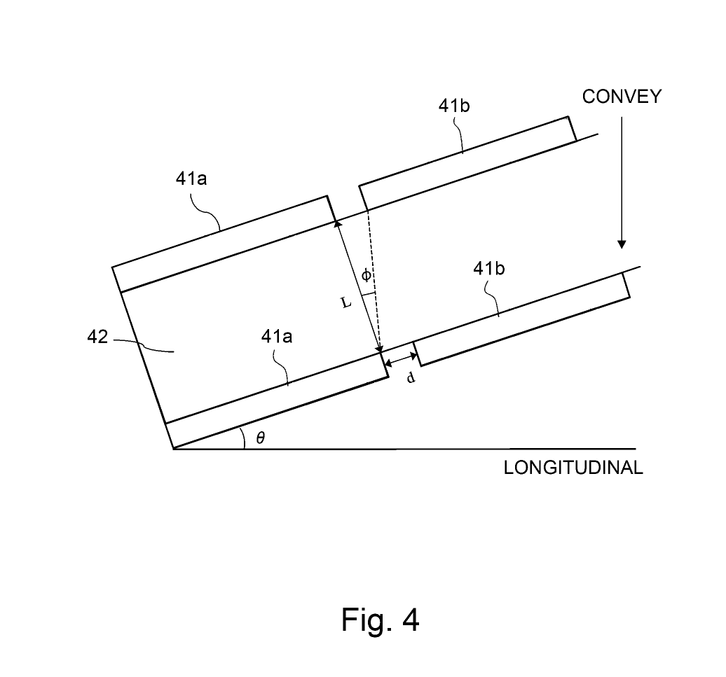

On a surface 39b1 of the substrate 39b in the fixing film sliding side, a heat generating resistor (heat generating resistor) 42 for generating heat by electric energy supply is formed in a thickness of about 10 μm by screen printing or the like. The heat generating resistor layer 42 is disposed from one end side (left side in (a) of FIG. 3) of the substrate 39b with respect to the longitudinal direction to another end side (right side in (a) of FIG. 3) of the substrate 39b with respect to the longitudinal direction, and crosses the recording material conveyance direction with a predetermined angle θ (FIG. 4). The heat generating resistor layer 42 is formed of a material such as RuO₂ (ruthenium oxide) or Ta₂N (tantalum nitride), and is uniform in resistance value per unit length with respect to a length direction which forms the predetermined angle θ with respect to the recording material conveyance direction. The angle θ formed between the recording material conveyance direction and the heat generating resistor layer 42 will be described.

On the substrate surface 39b1, three electroconductive patterns (plurality of electroconductive patterns) 41a, 41b and 41c for supplying electric power (energy) to the heat generating resistor layer 42 with respect to a widthwise direction, perpendicular to a length direction of the heat generating resistor layer 42, which forms the predetermined angle θ between itself and the recording material conveyance direction are formed by the screen printing or the like. These three electroconductive patterns 41a, 41b and 41c are disposed in each of end portion sides of the substrate 39b with respect to the widthwise direction along the length direction of the heat generating resistor layer 42 with a predetermined distance d (FIG. 4). These three electroconductive patterns 41a, 41b and 41c are formed of the same material as that for the heat generating resistor layer 42 and is uniform in resistance value per unit length with respect to the length direction of the heat generating resistor layer.

Further, on the substrate surface 39b1, the three electrodes 43a, 43b and 43c for independently supplying the electric power to the three electroconductive patterns 41a, 41b and 41c, respectively, by the screen printing or the like. These three electrodes 43a, 43b and 43c are electrically connected to the electroconductive patterns 41a, 41b and 41c, respectively.

Further, on the substrate surface 39b1, a protective layer 39b for protecting the heat generating resistor layer 42 and the electroconductive patterns 41a, 41b and 41c with a range not impairing heat efficiency is provided. It is desirable that the thickness of the protective layer 39b is sufficiently thin and is such that a surface property of the heater 39 is improved, and the protective layer has been subjected to glass coating, fluorine-containing resin coating or the like.

### (2-5) Heat-Fixing Operation of Fixing Apparatus B

A heat-fixing operation of the fixing apparatus B in this embodiment will be described with reference to FIG. 2 and (a) of FIG. 3. In the fixing apparatus B in this embodiment, a motor driving control circuit (not shown) rotationally drives a motor (not shown) depending on a print job signal. A rotational force of an output shaft of the motor is transmitted to a driving gear (not shown) provided at an end portion of the core metal 37 of the pressing roller 15, so that the pressing roller 15 is rotated in an arrow direction. The rotational force of the pressing roller 15 is transmitted to the fixing film 14 by a frictional force, at the fixing nip N, between the surface of the pressing roller 15 and the surface of the fixing film 14. That is, the pressing roller functions as the rotatable driving member for rotationally driving the fixing film 14. As a result, the fixing film 14 is rotated (moved) in the arrow direction by following rotation of the pressing roller 15 while sliding on the surface of the protective layer 39b at its inner peripheral surface.

A lubricant such as heat-resistant grease of a fluorine-containing resin type or a silicone type may preferably be interposed between the inner surface of the fixing film 14 and the protective layer 39b of the heater 39. As a result, frictional resistance between the inner surface of the fixing film 14 and the protective layer 39b can be suppressed at a low level, so that the fixing film 14 can be smoothly rotated.

Further, depending on the print job signal, either one of a first triac (electric power supplying portion) 405 and second triacs (electric power supplying portion) 406a and 406b is turned on by a temperature control circuit (controller) 407. Alternatively, both the first triac 405 and the second triacs 406a and 406b are turned on.

When the triac (first electric power supply control circuit portion) 405 is turned on, the electric power is supplied from an AC power source 408 to the electrode 43b of the heater 39, so that the electric power is supplied to the heat generating resistor layer 42 via the electroconductive pattern 41b with respect to the widthwise direction perpendicular to the length direction of the heat generating resistor 42 (widthwise electric power supply). As a result, heat is generated in a region (lengthwise central region of the heat generating resistor layer 42) corresponding to the electroconductive pattern 41b.

When the second triacs (second electric power supply control circuit portion) 406a and 406b are turned on, the electric power is supplied from the AC power source 408 to the electrodes 43a and 43c of the heater 39. When the electric power is supplied to the electrode 43a, the electric power is supplied to the heat generating resistor layer 42 via the electroconductive pattern 41a with respect to the widthwise direction perpendicular to the length direction of the heat generating resistor layer 42 (widthwise electric power supply). When the electric power is supplied to the electrode 43c, the electric power is supplied to the heat generating resistor layer 42 via the electroconductive pattern 41c with respect to the widthwise direction perpendicular to the length direction of the heat generating resistor layer 42 (widthwise electric power supply). As a result, heat is generated in regions (lengthwise end regions of the heat generating resistor layer 42) corresponding to the electroconductive patterns 41a and 41c.

By the heat generation in the lengthwise central region of the heat generating resistor layer 42 or both in the lengthwise central region and in the lengthwise end regions of the heat generating resistor layer 42, the heater 39 is quickly increased in temperature, so that the fixing film 14 is heated by the heater 39.

A temperature of the heater 39 is detected by thermistor (temperature detecting member) 305 provided at a longitudinal central portion of the protective layer 39b of the heater 39 in an opposite side to the fixing nip N. The heater control circuit 407 obtains an output signal from the thermistor 305. Then, on the basis of the output signal, the control circuit 407 determines and properly controls a duty ratio, wave number and the like of a voltage to be applied to the heat generating resistor layer 42 via the electroconductive patterns 41a, 41b and 41c to which the triacs 405, 406a and 406b correspond. As a result, the temperature in the fixing nip N is kept at a predetermined set fixing temperature (target temperature).

In a state in which the motor is rotationally driven and the heater temperature is kept at the predetermined set fixing temperature, the recording material S on which the unfixed toner images t are carried is guided into (passed through) the fixing nip N along an entrance guide 34 with a toner image carrying surface toward the fixing film 14. The recording material S is (nip-)conveyed while being nipped between the surface of the fixing film 14 and the surface of the pressing roller 15 at the fixing nip N, and in the conveying process, the unfixed toner images t are heat-fixed on the recording material S under application of heat of the heater 39 and nip pressure at the fixing nip N. The recording material S coming out of the fixing nip N is nipped and conveyed by a fixing and discharging roller pair 36 to be discharged from the fixing apparatus B.

### (2-6) Widthwise Electric Power Supply of Heater 39

FIG. 4 is an illustration showing a relationship among the substrate 39a, the heat generating resistor layer 42 and the electroconductive patterns 41a, 41b and 41c with respect to the longitudinal direction of the heater 39. In FIG. 4, the electroconductive pattern 41c is not illustrated but a distance d between adjacent electroconductive patterns 41a and 41b with respect to the longitudinal direction of the heat generating resistor layer 42 and a distance d between adjacent electroconductive patterns 41b and 41c with respect to the longitudinal direction of the heat generating resistor layer 42 are equal to each other.

In the heater 39, the heat generating resistor 42 is disposed to satisfy a formula (I) shown below. In this embodiment, in FIG. 4, an angle formed between a rectilinear line parallel to the longitudinal direction of the electroconductive pattern 41a (the electroconductive patterns 41b and 41c and the heat generating resistor layer 42) and a rectilinear line having a length L (minimum distance which is a length of the heat generating resistor layer 42 with respect to the widthwise direction perpendicular to the longitudinal direction of the heat generating resistor layer 42) is 90 degrees. That is, tang)=d/L is satisfied.

θ>tan⁻¹(d/L) (1)

In the formula (1), θ is an angle formed between the recording material conveyance direction and the heat generating resistor layer 42 (with the proviso that θ<90 degrees), d is the distance between adjacent ones of the electroconductive patterns 41a, 41b and 41c with respect to the longitudinal direction of the heat generating resistor 42, and L is a dimension (width) of the heat generating resistor layer 42 with respect to the widthwise direction perpendicular to the lengthwise direction of the heat generating resistor layer 42. The distance d may preferably be set so that the electric power is not supplied between the adjacent electroconductive patterns 41a and 41b or the adjacent electroconductive patterns 41b and 41c when the electric power is supplied to the electroconductive patterns 41a, 41b and 41c.

That is, in FIG. 4, the electrode pair 41a and the electrode pair 41b are provided so as to satisfy a positional relationship such that one (in a downstream side of the recording material conveyance direction) of the electrode pair 41a and one (in an upstream side of the recording material conveyance direction) of the electrode pair 41b overlap with each other as seen from the recording material conveyance direction. Similarly the electrode pairs 41b and 41c are provided so as to satisfy a positional relationship such that one (in the downstream side of the recording material conveyance direction) of the electrode pair 41b and one (in the upstream side of the recording material conveyance direction) of the electrode pair 41c overlap with each other as seen from the recording material conveyance direction. In other words, when the respective electrode pairs are disposed so that ones of the adjacent electrode pairs (41a, 41b and 41e) provide a mutually overlapping positional relationship.

In this embodiment, in the heater 39, the substrate 39a was 260 mm in longitudinal (long) width, 10 mm in widthwise (short) width, 0.2 mm in distance d, 5 mm in width L and 2.5 degrees in angle θ. By employing such a constitution, regions between the adjacent electroconductive patterns 41a and 41b and between the adjacent electroconductive patterns 41a and 41b, where a current is not readily carried are not concentrated at the same position with respect to the longitudinal direction of the substrate 39a, so that the regions can be dispersed. This will be described later with reference to FIG. 6.

In this embodiment, for convenience of explanation, the length of the central electroconductive pattern 41b of the three electroconductive patterns 41a, 41b and 41c corresponds to that of a small-sized recording material, such as envelope, having a narrow longitudinal width.

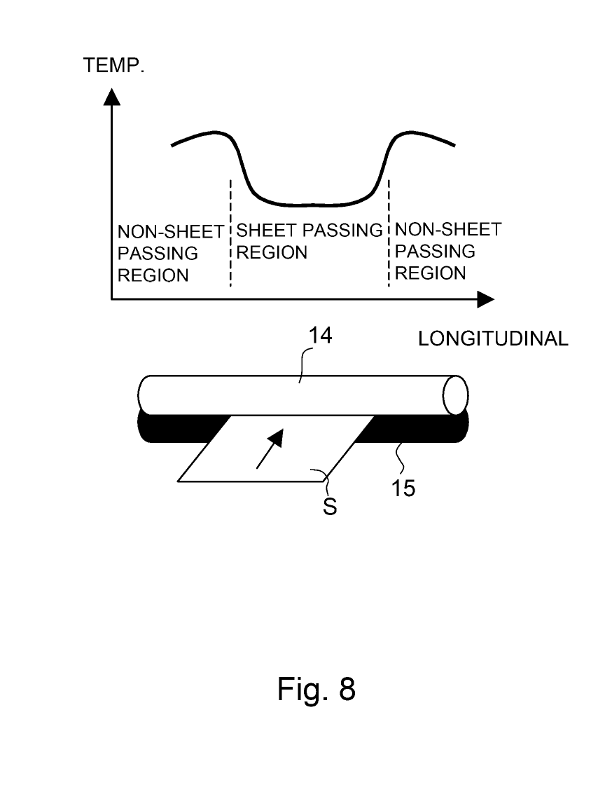

With reference to FIG. 8, non-sheet-passing portion temperature rise of the fixing apparatus B will be described. With the small-sized recording material S narrower in width than a large-sized recording material S is passed through the fixing nip N of the fixing apparatus B, at the fixing nip N, a region (sheet passing region) where the small-sized recording material S passes and a region (non-sheet passing region) where the small-sized recording material S passes are generated. The heat is taken by the recording material S in the sheet passing region but is not taken by the recording material S in the non-sheet passing region, and therefore a temperature difference between the sheet passing region and the non-sheet passing region becomes large. For this reason, as shown in FIG. 8, with respect to the width of the fixing apparatus B with respect to the longitudinal direction, when the relatively small recording material (small-sized paper) is passed through the fixing nip N, the temperature difference between the sheet passing region and the non-sheet passing region with respect to the longitudinal direction of the heater 39 becomes large (non-sheet-passing portion temperature rise).

When the small-sized recording material is passed through the fixing nip N, a voltage is applied to the central electroconductive pattern 41b, so that the electric power is supplied to the heat generating resistor layer 42 with respect to the widthwise direction. As a result, the heat generating resistor layer 42 generates heat at the lengthwise central portion corresponding to the electroconductive pattern 41b, and therefore it is possible to achieve a print speed comparable to that of a full-sized recording material.

When the full-sized recording material such as the recording material of LTR size, with respect to the longitudinal width, corresponding to a full length of the heat generating resistor layer 42 is passed through the fixing nip N, the voltage is applied to all the electroconductive patterns 41a, 41b and 41c, so that the electric power is supplied to the heat generating resistor layer 42 with respect to the widthwise direction. Thus, the heat generating resistor layer 42 generates heat at the lengthwise end and central portions corresponding to the electroconductive patterns 41a, 41b and 41c, so that the printing is performed by control similar to conventional control.

When a so-called medium-sized recording material larger than the small-sized recording material and smaller than the full-sized recording material with respect to the longitudinal width is passed through the fixing nip N, a predetermined voltage lower than the voltage to be applied to the electroconductive pattern 41b is applied to the electroconductive patterns 41a and 41c. Thus, electric power control such that heat generation at the lengthwise end portions of the heat generating resistor layer 42 corresponding to the electroconductive patterns 41a and 41c is suppressed, and that it is different from the electric power control at the lengthwise central portion of the heat generating resistor layer 42 corresponding to the electroconductive pattern 41b is effected. As a result, it is possible to effect balanced control between a fixing property of the unfixed toner image and suppression of non-sheet-passing portion temperature rise. Thus, also with respect to the medium-sized recording material, speed-up can be achieved.

As described above, the heater 39 in this embodiment independently supplies the electric power to the electroconductive patterns 41a, 41b and 41c by the first triac 405 and the second triacs 406a and 406b. For that reason, it is possible to effect electric power control of each of the electroconductive patterns 41a, 41b and 41c. As a result, by subjecting each of the electroconductive patterns 41a, 41b and 41c to ON/OFF control, so that it becomes possible to control a temperature distribution of the heat generating resistor layer 42 with respect to the longitudinal direction.

Comparison of longitudinal temperature distribution (longitudinal glossiness distribution) between the heater 39 in this embodiment and a heater 391 in Comparison example was made. A result thereof is shown in (a) and (b) of FIG. 6.

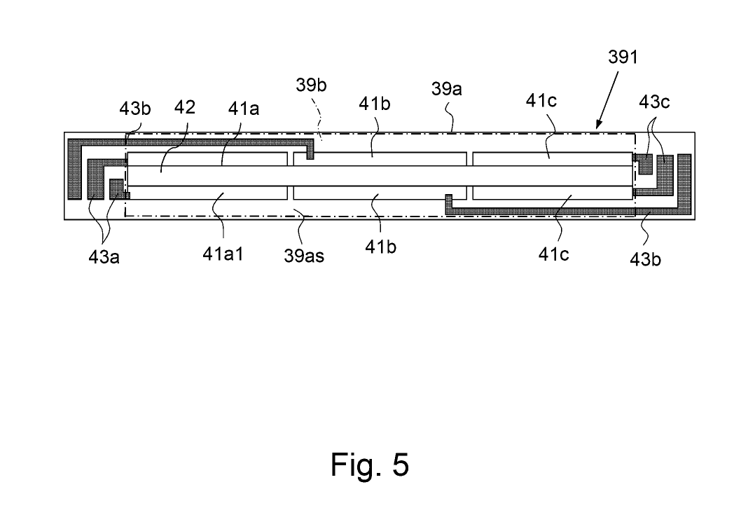

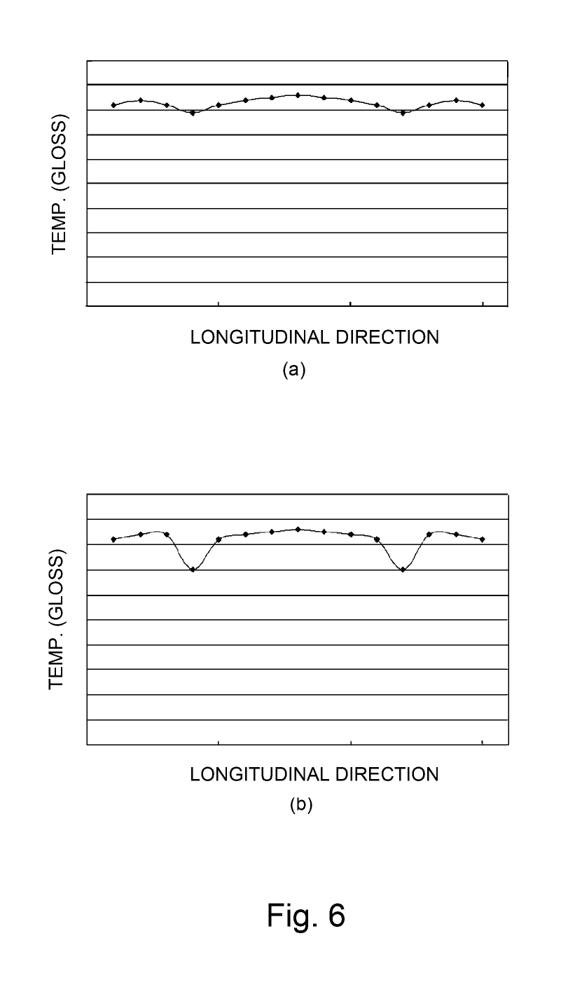

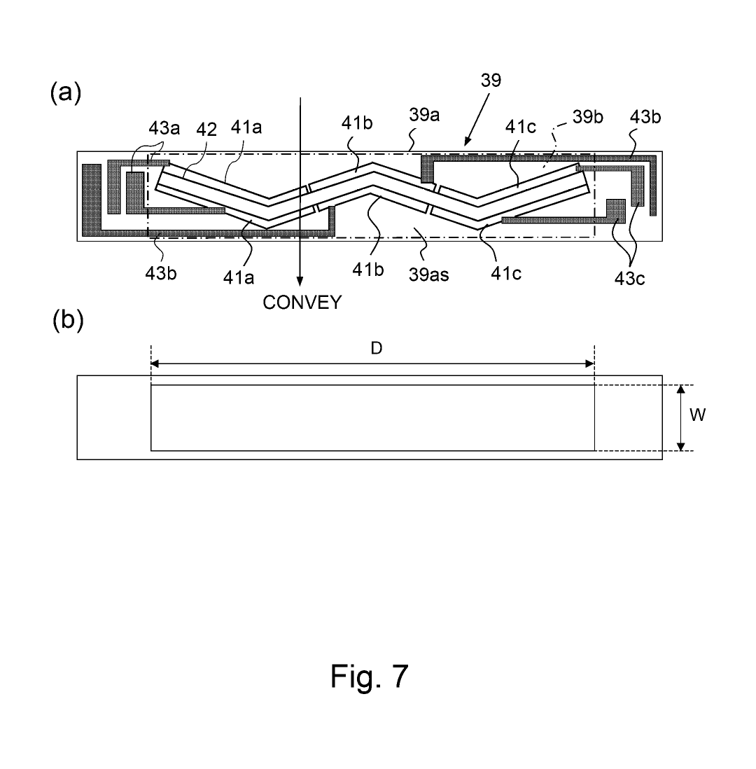

FIG. 5 is a front view showing a general structure of the heater 391 in Comparison example in the fixing film sliding side. The heater 391 in Comparison example has the same constitution as that of the heater 39 in this embodiment except that the electroconductive patterns 41a, 41b and 41c are formed along the longitudinal direction of the substrate 39a in each of end portion sides with respect to the widthwise direction of the substrate 39a.

Parts (a) and (b) of FIG. 6 are graphs showing a difference of a temperature distribution (glossiness distribution) with respect to the longitudinal direction of the heater 39 in this embodiment and of the heater 391 in Comparison example, respectively. In FIG. 6, (a) shows a measurement result when the heater 39 in this embodiment is used, and (b) shows a measurement result when the heater 391 in Comparison example is used.

With respect to the measurement in this embodiment, the longitudinal temperature distribution of the heater immediately before passing of a first sheet. As shown in (a) of FIG. 6, in the heater 39 in this embodiment, a constitution in which the region where the current is not readily carried on the electric power supply heat generating resistor layer 42 is not concentrated at the same position (portion) but is dispersed with respect to the longitudinal direction of the substrate 39a is employed. On the other hand, as shown in (b) of FIG. 6, in the heater 391 in this embodiment, on the heat generating resistor layer 42, the region where the current is not readily carried is concentrated at the longitudinal same position.

For that reason, in the heater 39 in this embodiment, with respect to the longitudinal direction of the substrate 39a, a temperature lowering region is enlarged compared with the heater 391 in Comparison example, but the temperature distribution difference (temperature difference between the highest temperature and the lowest temperature) can be reduced.

As described above, in the heater 39 in this embodiment, the three electroconductive patterns 41a, 41b and 41c are disposed along the lengthwise direction of the heat generating resistor layer 42 with the predetermined distance d. For that reason, the electric power supply region of the heat generating resistor 42 with respect to the longitudinal direction can be caused to selectively generate heat depending on the size of the recording material. For that reason, the fixing apparatus B including the heater 39 in this embodiment can achieve efficient heat supply to the heater 39 while suppressing the non-sheet-passing portion temperature rise and speed-up of the printing speed of the small-sized recording material.

Further, the region, where the current is not readily carried, corresponding to the distance d between the adjacent electroconductive patterns 41a and 41b or between the adjacent electroconductive patterns 41b and 41c with respect to the lengthwise direction of the heat generating resistor layer 42 is dispersed with respect to the longitudinal direction of the substrate 39a, i.e., the above-described formula (1) is satisfied. For that reason, the temperature distribution difference of the heat generating resistor layer 42 with respect to the longitudinal direction of the substrate 39a can be made small. For that reason, the fixing apparatus B including the heater 39 in this embodiment can suppress an occurrence of improper fixing due to insufficient temperature and an occurrence of uneven glossiness due to the temperature difference, and the like.

### Embodiment 2

Another example of the heater 39 will be described. In Embodiment 1, the heater 39 having the constitution in which the heat generating resistor layer 42 and the electroconductive patterns 41a, 41b and 41c were disposed in straight line was described. In this embodiment, the heater 39 having a constitution in which the heat generating resistor layer 42 and the electroconductive patterns 41a, 41b and 41c are disposed in a partly folded (bent) manner will be described.

The heater 39 in this embodiment will be described with reference to FIG. 7. In FIG. 7, (a) is a front view showing a general structure of the heater 39 in the fixing film sliding side, and (b) is an illustration showing a certain condition for disposing the heat generating resistor layer 42 and the electroconductive patterns 41a, 41b and 41c on the substrate 39a.

In the heater 39 in this embodiment, the distance d each of between the adjacent electroconductive patterns 41a and 41b and between the adjacent electroconductive patterns 41b and 41c was 0.5 mm, and the width L of the heat generating resistor layer 42 was 5 mm. In this case, in order to satisfy the relationship of the above-described formula (1), there is a need to set θ at a value larger than about 5.71 degrees. In this embodiment, e was set at 6 degrees.

The reason why the (partly) folding constitution is employed with respect to the heat generating resistor layer 42 and the electroconductive patterns 41a, 41b and 41c will be described below. As shown in (b) of FIG. 7, the width of the region where the heat generating resistor layer 42 is disposed is W with respect to the widthwise direction of the substrate 39a, and the length of the region where the heat generating resistor layer 42 is disposed is D with respect to the longitudinal direction of the substrate 39a. In this case, the constitution in Embodiment 1 in which the heat generating resistor layer 42 is disposed in the straight line can be employed when a condition: (W/D)>(d/L) is satisfied.

In this embodiment, W=10 mm and D=312 mm were set. In this case, in the constitution in Embodiment 1 such that the heat generating resistor layer 42 is disposed in the straight line, the above-described condition of θ (θ> about 5.71 degrees) cannot be satisfied. In other words, the condition: (W/D)>(d/L) cannot be satisfied. Therefore, in the case where the values of the width W, the length D, the distance d between the adjacent electroconductive patterns and the width L of the heat generating resistor layer 42 in this embodiment are used, the constitution, in which the heat generating resistor layer and the three electroconductive patterns are disposed in the straight time, employed in Embodiment 1 cannot be employed.

Therefore, in this embodiment, as shown in (a) of FIG. 7, the heat generating resistor layer 42 and the electroconductive patterns 41a, 41b and 41c are disposed in the partly folded manner (the number of folding=3), so that a constitution satisfying the condition of the formula (I) is employed. That is, in the heater 39 in this embodiment, in the case where the condition: (W/D)<(d/L) is satisfied, a constitution in which the heat generating resistor layer 42 and the electroconductive patterns 41a, 41b and 41c are disposed so as not to be arranged in the straight line with respect to the longitudinal direction of the substrate 29a is employed. Specifically, in the constitution, the heat generating resistor layer 42 and the electroconductive patterns 41a, 41b and 41c are disposed by being partly folded with respect to the widthwise direction of the substrate 39a in a zigzag manner with respect to the longitudinal direction of the substrate 39a.

As described above, also in the heater 39 in this embodiment, the three electroconductive patterns 41a, 41b and 41c are disposed along the longitudinal direction of the heat generating resistor layer 42 with the predetermined distance d. For that reason, the electric power supply region of the heat generating resistor 42 with respect to the longitudinal direction can be caused to selectively generate heat depending on the size of the recording material. For that reason, the fixing apparatus B including the heater 39 in this embodiment can achieve efficient heat supply to the heater 39 while suppressing the non-sheet-passing portion temperature rise and speed-up of the printing speed of the small-sized recording material.

Further, the region, where the current is not readily carried, corresponding to the distance d between the adjacent electroconductive patterns 41a and 41b or between the adjacent electroconductive patterns 41b and 41c with respect to the longitudinal direction of the heat generating resistor layer 42 is dispersed with respect to the longitudinal direction of the substrate 39a, so that the temperature distribution difference of the heat generating resistor layer 42 with respect to the longitudinal direction of the substrate 39a can be made small. For that reason, the fixing apparatus B including the heater 39 in this embodiment can suppress an occurrence of improper fixing due to insufficient temperature and an occurrence of uneven glossiness due to the temperature difference, and the like.

### Other Embodiments

In the heaters 39 in Embodiments 1 and 2, the three electroconductive patterns 41a, 41b and 41c are disposed along the longitudinal direction of the heat generating resistor layer 42 so as to be capable of supplying the electric power thereto with respect to the widthwise direction of the heat generating resistor layer 42. However, the number of the electroconductive patterns is not limited to three but may appropriately be set depending on the size of the recording material.

In the heater 39 in Embodiment 2, the zigzag shape of the heat generating resistor layer 42 and the electroconductive patterns 41a, 41b and 41c is not limited to that described in Embodiment 2, but may only be required to satisfy the condition of the formula (1) by adjusting the number of folding of the zigzag shape depending on the width of the heater 39 with respect to the widthwise direction or the longitudinal direction. Further, the constitution of the heat generating resistor layer 42 and the electroconductive patterns 41a, 41b and 41c is not limited to the folding constitution in the zigzag shape but may also be such a constitution that the heat generating resistor layer 42 and the electroconductive patterns 41a, 41b and 41c are arranged obliquely with respect to the longitudinal direction of the substrate 39a in parallel to each other.

The use of the fixing apparatus B in the present invention is not limited to use as an apparatus for heat-fixing the unfixed toner images t, carried on the recording material S, on the recording material S. For example, the fixing apparatus B can be used also as an apparatus for increasing glossiness of the toner image by heating the toner image fixed on the recording material.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 110421/2012 filed May 14, 2012, which is hereby incorporated by reference.

What is claimed is:

1. A heater comprising:
a substrate;
a resistor, provided obliquely on said substrate with respect to a sheet passing direction, for generating heat by electric energy supply;
a pair of first electrodes which are disposed opposed to each other via said resistor and which are electrically connected with respective ends of said resistor with respect to the sheet passing direction; and
a pair of second electrodes which are disposed opposed to each other via said resistor and which are electrically connected with respective ends of said resistor with respect to the sheet passing direction,
wherein one of the first electrodes and one of the second electrodes overlap with each other as seen from the sheet passing direction.

2. A heater according to claim 1, wherein said one of the first electrodes is a downstream electrode with respect to the sheet passing direction, and said one of the second electrodes is an upstream electrode with respect to the sheet passing direction.

3. A heater according to claim 2, wherein when an angle formed between a longitudinal direction of said resistor and the sheet passing direction is θ, a spacing between one of the first electrodes and one of the second electrodes, which ones are in a mutually adjacent positional relationship with respect to a longitudinal direction of said substrate is d, and a length of said resistor with respect to a widthwise direction is L, the following relationship is satisfied:
tan⁻¹(d/L)<θ<90 degrees.

4. A heater according to claim 1, further comprising:
a pair of third electrodes which are disposed opposed to each other via said resistor and which are electrically connected with respective ends of said resistor with respect to the sheet passing direction,
wherein one of the second electrodes and one of the third electrodes overlap with each other as seen from the sheet passing direction.

5. A heater according to claim 4, wherein said one of the second electrodes is a downstream electrode with respect to the sheet passing direction, and said one of the third electrodes is an upstream electrode with respect to the sheet passing direction.

6. A heater according to claim 5, wherein when an angle formed between a longitudinal direction of said resistor and the sheet passing direction is θ, a spacing between one of the second electrodes and one of the third electrodes, which ones are in a mutually adjacent positional relationship with respect to a longitudinal direction of said substrate is d, and a length of said resistor with respect to a widthwise direction is L, the following relationship is satisfied:
tan⁻¹(d/L)<θ<90 degrees.

7. An image heating apparatus comprising:
(i) an endless belt for heating an image on a sheet at a nip;
(ii) a rotatable driving member for forming the nip in cooperation with said endless belt and for driving said endless belt;
(iii) a heater, provided to sandwich said endless belt between itself and said rotatable driving member, for heating said endless belt,
wherein said endless belt comprises:
(iii-1) a substrate;
(iii-ii) a resistor, provided obliquely on said substrate with respect to a sheet passing direction, for generating heat by electric energy supply;
(iii-iii) a pair of first electrodes which are disposed opposed to each other via said resistor and which are electrically connected with respective ends of said resistor with respect to the sheet passing direction; and
(iii-iv) a pair of second electrodes which are disposed opposed to each other via said resistor and which are being electrically connected with respective ends of said resistor with respect to the sheet passing direction,
wherein one of the first electrodes and one of the second electrodes overlap with each other as seen from the sheet passing direction.

8. An apparatus according to claim 7, wherein said one of the first electrodes is a downstream electrode with respect to the sheet passing direction, and said one of the second electrodes is an upstream electrode with respect to the sheet passing direction.

9. An apparatus according to claim 8, wherein when an angle formed between a longitudinal direction of said resistor and the sheet passing direction is θ, a spacing between one of the first electrodes and one of the second electrodes, which ones are in a mutually adjacent positional relationship with respect to a longitudinal direction of said substrate is d, and a length of said resistor with respect to a widthwise direction is L, the following relationship is satisfied:
tan⁻¹(d/L)<θ<90 degrees.

10. An apparatus according to claim 7, further comprising:
a pair of third electrodes which are disposed opposed to each other via said resistor and which are electrically connected with respective ends of said resistor with respect to the sheet passing direction,
wherein one of the second electrodes and one of the third electrodes overlap with each other as seen from the sheet passing direction.

11. An apparatus according to claim 10, wherein said one of the second electrodes is a downstream electrode with respect to the sheet passing direction, and said one of the third electrodes is an upstream electrode with respect to the sheet passing direction.

12. An apparatus according to claim 11, wherein when an angle formed between a longitudinal direction of said resistor and the sheet passing direction is θ, a spacing between one of the second electrodes and one of the third electrodes is d, and a length of said resistor with respect to a widthwise direction is L, the following relationship is satisfied:
tan⁻¹(d/L)<θ<90 degrees.

13. An apparatus according to claim 7, further comprising:
a first electric power supplying portion for supplying electric power between the first electrodes;
a second electric power supplying portion for supplying the electric power between the second electrodes; and
a controller for controlling an operation of each of said first electric power supplying portion and said second electric power supplying portion depending on a size of the sheet with respect to a widthwise direction of the sheet.
